(19) United States
(12) Patent Application Publication
(10) Pub. No.: US 2024/0232639 A1
(43) Pub. Date: Jul. 11, 2024

(54) RETRAINING SYSTEM, INSPECTION SYSTEM, EXTRACTION DEVICE, RETRAINING METHOD, AND STORAGE MEDIUM

(71) Applicant: KABUSHIKI KAISHA TOSHIBA, Tokyo (JP)

(72) Inventors: Miyuki UCHIDA, Yokohama Kanagawa (JP); Taisuke WASHITANI, Yokohama Kanagawa (JP)

(21) Appl. No.: 18/409,017

(22) Filed: Jan. 10, 2024

(30) Foreign Application Priority Data
Jan. 11, 2023 (JP) 2023-002679

(51) Int. Cl. G06N 3/09; G06N 3/0464

(52) U.S. Cl. CPC G06N 3/09; G06N 3/0464

(57) ABSTRACT

According to one embodiment, a retraining system retrains a neural network trained by using multiple first training data as input data, and multiple first output results as output data; and includes first and second extractors, a clustering part, and an updater. The first extractor inputs the multiple first training data to the neural network and extracts multiple first feature data from an intermediate layer of the neural network, and inputs new multiple second training data to the neural network and extracts multiple second feature data from the intermediate layer. The clustering part splits the multiple first and second feature data into multiple classes. The second extractor extracts a portion of the multiple first feature data and of the multiple second feature data from the multiple classes. The updater updates the neural network by using a portion of the multiple first training data and of the multiple second training data.

### CROSS-REFERENCE TO RELATED APPLICATIONS

This application is based upon and claims the benefit of priority from Japanese Patent Application No. 2023-002679, filed on Jan. 11, 2023; the entire contents of which are incorporated herein by reference.

### FIELD

Embodiments described herein relate generally to a retraining system, an inspection system, an extraction device, a retraining method, and a storage medium.

### BACKGROUND

Artificial intelligence (AI) using neural networks is utilized in various situations. The accuracy of a neural network can be increased by training the neural network with a large amount of data. On the other hand, the accuracy of the neural network decreases when the trend of the input data changes. The neural network is retrained as appropriate to improve the accuracy of the neural network. It is desirable to reduce the time necessary for retraining.

### BRIEF DESCRIPTION OF THE DRAWINGS

FIG. 1 is a schematic view showing a configuration of a retraining system according to an embodiment;

FIG. 2 is a schematic view for describing an extraction method of training data;

FIG. 3 is a flowchart showing a retraining method according to the embodiment;

FIG. 4 is a schematic view showing a configuration of an inspection system according to the embodiment;

FIG. 5 is a schematic view showing an example of a neural network for classifying;

FIG. 6 is a schematic view for describing an extraction method of the training data;

FIGS. 7A and 7B are schematic views for describing the extraction method of the training data;

FIG. 8 is a schematic view showing another example of a neural network for classifying;

FIG. 9 is a schematic view showing an example of a neural network for segmentation; and

FIG. 10 is a schematic view showing a hardware configuration.

### DETAILED DESCRIPTION

According to one embodiment, a retraining system retrains a neural network trained by using multiple first training data as input data and by using multiple first output results as output data. The retraining system includes a first extractor, a clustering part, a second extractor, and an updater. The first extractor inputs the multiple first training data to the neural network and respectively extracts multiple first feature data from an intermediate layer of the neural network. The first extractor inputs multiple second training data to the neural network and respectively extracts multiple second feature data from the intermediate layer. The multiple second training data are new. The clustering part splits the multiple first feature data and the multiple second feature data into multiple classes. The second extractor extracts a portion of the multiple first feature data and a portion of the multiple second feature data from the multiple classes to reduce differences between ratios of data quantities among the multiple classes. The updater updates the neural network by using a portion of the multiple first training data and a portion of the multiple second training data. The portion of the multiple first training data corresponds to the portion of the multiple first feature data, and the portion of the multiple second training data corresponds to the portion of the multiple second feature data.

Various embodiments will be described hereinafter with reference to the accompanying drawings. In the specification and drawings, components similar to those described or illustrated in a drawing thereinabove are marked with like reference numerals, and a detailed description is omitted as appropriate.

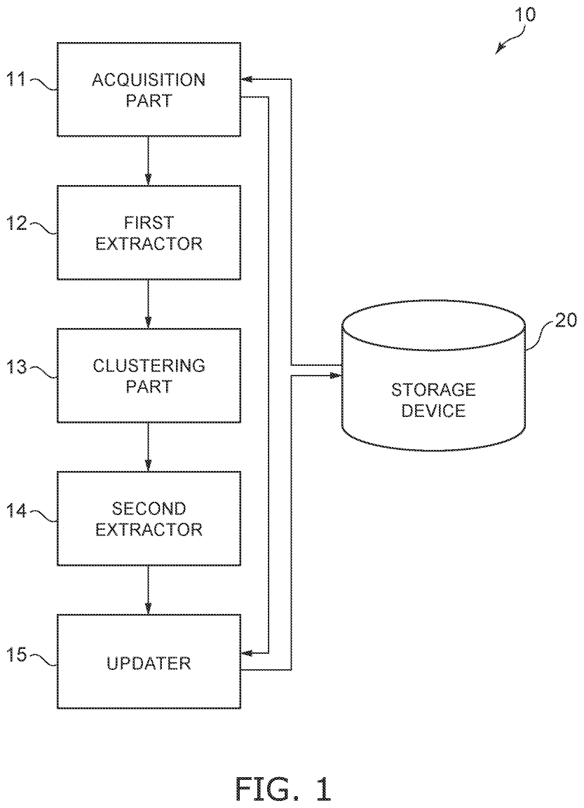

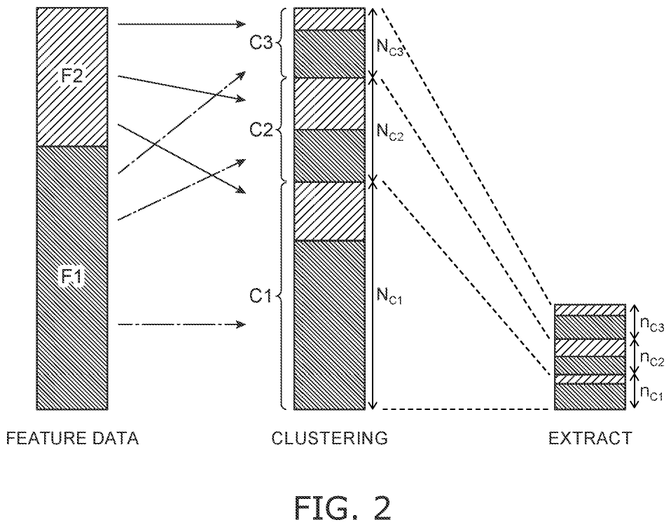

FIG. 1 is a schematic view showing a configuration of a retraining system according to an embodiment. FIG. 2 is a schematic view for describing an extraction method of training data.

As shown in FIG. 1, the retraining system 10 according to the embodiment includes an acquisition part 11, a first extractor 12, a clustering part 13, a second extractor 14, an updater 15, and a storage device 20.

The acquisition part 11 references a trained neural network 100 stored in the storage device 20. The neural network 100 is trained by supervised learning. Multiple first training data and multiple first output results corresponding respectively to the multiple first training data are used to train the neural network 100. The neural network 100 receives input of the first training data and is trained to output the first output result corresponding to the first training data.

The content of the first training data, the content of the first output result, and the specific configuration of the neural network 100 can be selected as appropriate according to the processing to be performed by the neural network 100. As an example, the neural network 100 performs classification. The first training data is an image; and the first output result is a classification (a label) of the first training data. The first training data may be a voice, video image, time-series data (numerical values), character strings, etc.; and the first output result may be a classification of such data. As another example, the neural network 100 performs image generation. The first training data is an image, voice, time-series data (numerical values), or character strings; and the first output result is an image that is generated. The neural network 100 may perform segmentation. In such a case, the first training data is an image; and the first output result is a result in which the image is split into multiple objects. The neural network 100 may perform object detection. In such a case, the first training data is an image; and the first output result is the result of the position, type, and number of objects appearing in the image. The neural network 100 may perform a regression. In such a case, the first training data is an image, voice, time-series data (numerical values), or character strings; and the first output result is another value.

The acquisition part 11 acquires the neural network 100, the multiple first training data, and the multiple first output results from the storage device 20. The acquisition part 11 also acquires new multiple second training data and second output results corresponding respectively to the multiple second training data from the storage device 20. The second training data is different from the first training data, and is data that has not yet been used to train the neural network 100. The acquisition part 11 outputs the neural network 100, the multiple first training data, and the multiple second training data to the first extractor 12.

The first extractor 12 inputs the first training data to the neural network 100 and extracts first feature data from an intermediate layer of the neural network 100. The first extractor 12 sequentially inputs the multiple first training data to the neural network 100 and extracts the multiple first feature data. The first extractor 12 also inputs the second training data to the neural network 100 and extracts the second feature data from the intermediate layer of the neural network 100. The first extractor 12 sequentially inputs the multiple second training data to the neural network 100 and extracts the multiple second feature data. The first extractor 12 outputs the multiple first feature data and the multiple second feature data to the clustering part 13.

The clustering part 13 clusters the multiple first feature data and the multiple second feature data. As a result, the multiple first feature data and the multiple second feature data are split into multiple classes. A method such as k-means, spectral clustering, DBSCAN, or the like can be used for the clustering. The clustering part 13 outputs the result of the clustering to the second extractor 14.

The second extractor 14 extracts a portion of the multiple first feature data and a portion of the multiple second feature data from the multiple classes. At this time, the second extractor 14 extracts the feature data to reduce differences between ratios of data quantities among the multiple classes.

As one specific example as shown in FIG. 2, the clustering part 13 clusters multiple first feature data F1 and multiple second feature data F2. As a result, the multiple first feature data F1 and the multiple second feature data F2 are split into a class C1 (an example of a first class), a class C2 (an example of a second class), and a class C3. The quantity of the first and second feature data split into the class C1 is N_{C1}. The quantity of the first and second feature data split into the class C2 is N_{C2}. The quantity of the first and second feature data split into the class C3 is N_{C3}.

The second extractor 14 randomly extracts a portion of the multiple first feature data F1 and a portion of the multiple second feature data F2 from each of the classes C1 to C3. As a result, the quantity of the first and second feature data extracted from the class C1 is n_{C1}. The quantity of the first and second feature data extracted from the class C2 is in n_{C2}. The quantity of the first and second feature data extracted from the class C3 is n_{C3}. The ratio n_{C2}/n_{C1} of the quantity n_{C2} to the quantity n_{C1} is closer to 1 than the ratio N_{C2}/N_{C1} of the quantity N_{C2} to the quantity N_{C1}. The ratio n_{C3}/n_{C2} of the quantity n_{C3} to the quantity n_{C2} is closer to 1 than the ratio N_{C3}/N_{C2} of the quantity N_{C3} to the quantity N_{C2}. The ratio n_{C3}/n_{C1} of the quantity n_{C3} to the quantity n_{C2} is closer to 1 than the ratio N_{C3}/N_{C1} of the quantity N_{C3} to the quantity N_{C1}.

When the quantity of the feature data included in one of the classes C1 to C3 and the quantity of the feature data included in another one of the classes C1 to C3 are equal, the ratios of the quantities of the feature data extracted from the classes may not be changed. Although the second extractor 14, as a general rule, extracts the feature data from the classes to reduce the differences between the ratios of the data quantities, there may be exceptional cases where the ratio is unchanged.

The second extractor 14 outputs, to the updater 15, the extracted portion of the multiple first feature data and the extracted portion of the multiple second feature data. The acquisition part 11 also outputs the multiple first training data, the multiple first output results, the multiple second training data, and the multiple second output results to the updater 15.

The updater 15 selects the first training data from the multiple first training data that corresponds to the extracted first feature data. In other words, the updater 15 selects the first training data that was the basis for the extracted first feature data. Similarly, the updater 15 selects the second training data from the multiple second training data that corresponds to the extracted second feature data. The updater 15 selects the same quantity of training data as the feature data extracted by the second extractor 14.

The updater 15 updates the neural network 100 by using the selected portion of the multiple first training data and the selected portion of the multiple second training data. Specifically, the updater 15 trains the neural network 100 by using the selected first training data as the input data and by using the first output results corresponding to the first training data as the output data. Also, the updater 15 trains the neural network 100 by using the selected second training data as the input data and by using the second output results corresponding to the second training data as the output data. The order of the data to be trained is arbitrary. Either the first training data or the second training data may be used first for the training. The first training data and the second training data may be used alternately. Or, the first training data and the second training data may be used simultaneously.

After updating the neural network 100, it is determined whether or not the retraining has ended. For example, an end condition is set so that the accuracy of the neural network 100 after the update is greater than a preset threshold. Specifically, the second extractor 14 or the updater 15 inputs test data to the neural network 100 and obtains an output from the neural network 100. The test data is different from the first and second training data. The output from the neural network 100 and the correct data corresponding to the test data are compared, and it is determined whether or not the correct result is output from the neural network 100. The multiple test data is sequentially input to the neural network 100; and the accuracy of the neural network 100 is calculated based on the output from the neural network 100. The second extractor 14 or the updater 15 determines whether or not the accuracy is greater than the threshold.

Other than the accuracy of the neural network 100, the loss of the neural network 100 may be used as the end condition. The loss is the error between the correct solution and the output of the neural network 100. For example, the loss of the neural network 100 after the update being less than a preset threshold is set as the end condition. Or, as the end condition, the update of the neural network 100 may be performed a preset number of times. The neural network 100 is updated by using the training data corresponding to the feature data extracted by the second extractor 14. The end condition may be set by selecting at least two from the accuracy of the neural network 100 being greater than a threshold, the loss of the neural network 100 being less than a threshold, and the updating being performed a prescribed number of times. In such a case, the retraining ends when one or all of the conditions are satisfied.

When the retraining is determined not to have ended, the second extractor 14 re-extracts a portion of the multiple first feature data and a portion of the multiple second feature data from the multiple classes. In such a case as well, the second extractor 14 extracts the feature data to reduce the differences between the ratios of the data quantities among the multiple classes. The second extractor 14 may extract different data from the data extracted up to that point. The updater 15 updates the neural network 100 by using the extracted data.

The retraining proceeds by alternately repeating the extraction of the data and the update of the neural network 100 by using the extracted data until the end condition is satisfied. When the retraining is determined to have ended, the updater 15 stores the updated neural network 100 in the storage device 20.

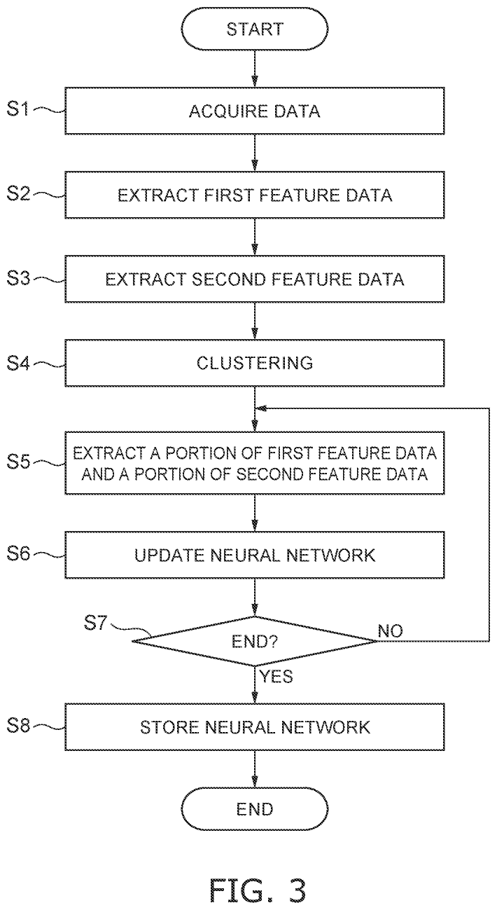

FIG. 3 is a flowchart showing a retraining method according to the embodiment.

First, the acquisition part 11 acquires the data to be used in the retraining (step S1). The acquired data is the neural network 100, the multiple first training data, the multiple first output results, the multiple second training data, and the multiple second output results. The first extractor 12 inputs the multiple first training data to the neural network 100 and respectively extracts the multiple first feature data from the intermediate layer (step S2). The first extractor 12 inputs the multiple second training data to the neural network 100 and respectively extracts the multiple second feature data from the intermediate layer (step S3). The clustering part 13 performs clustering to split the multiple first feature data and the multiple second feature data into multiple classes (step S4).

The second extractor 14 extracts a portion of the multiple first feature data and a portion of the multiple second feature data from the multiple classes to reduce the differences between the ratios of the data quantities among the multiple classes (step S5). The updater 15 updates the neural network 100 by using a portion of the multiple first training data corresponding to the extracted portion of the multiple first feature data and a portion of the multiple second training data corresponding to the extracted portion of the multiple second feature data (step S6). The second extractor 14 or the updater 15 determines whether or not the retraining has ended (step S7). When the retraining has not ended, step S5 is re-performed. When the retraining has ended, the updater 15 stores the retrained neural network 100 (step S8).

Advantages of the embodiment will now be described.

To sufficiently improve the accuracy of a neural network by retraining, it is favorable to train with much data. On the other hand, if a large data quantity is used to retrain, the retraining requires a long period of time. There are cases where the accumulated data includes data of various trends; and the data quantities are nonuniform between the trends. In such a case, the training may not easily progress for small-scale data; the retraining time of the neural network may further increase; and the accuracy for the small-scale data may decrease.

For these problems, in the invention according to the embodiment, first, the multiple first training data and the multiple second training data are input to the neural network. Then, the multiple first feature data and the multiple second feature data are extracted from the intermediate layer. When the multiple first feature data and the multiple second feature data are extracted, this quantified data is split into multiple classes. The data that is extracted from the intermediate layer represents features of the training data associated with the output results. Also, the data that is extracted from the intermediate layer is quantified. Therefore, the data that is extracted from the intermediate layer can be clustered according to the features regardless of the format of the training data.

After the clustering, a portion of the multiple first feature data and a portion of the multiple second feature data are extracted from the multiple classes to reduce the differences between the ratios of the data quantities among the multiple classes. Because a portion of the training data is extracted, the time necessary for the retraining can be reduced. By extracting the data from multiple classes, a bias toward a specific trend in the data used in the retraining can be suppressed. By reducing the differences between the ratios of the data quantities among the multiple classes, the ratio difference between small-scale data and large-scale data can be small, and the training for the small-scale data can be promoted.

After the data is extracted, the neural network 100 is updated using a portion of the multiple first training data corresponding to the portion of the multiple first feature data and a portion of the multiple second training data corresponding to the portion of the multiple second feature data.

According to the invention according to the embodiment, data that is more suited to retraining can be extracted. Also, by updating the neural network using the extracted data, the time necessary for retraining can be reduced while suppressing a reduction of the accuracy of the neural network.

The intermediate layer from which the feature data is extracted is arbitrary. Favorably, the first extractor 12 extracts the first and second feature data from a layer positioned at the output layer side among the multiple layers included in the intermediate layer. This is because the values output by layers more proximate to the output layer side better represent features associated with the output result of the training data.

As the most favorable example, the first extractor 12 extracts the first and second feature data from the layer directly before the output layer. This is because values that best represent features associated with the output result of the training data are obtained from the layer directly before the output layer.

When the clustering part 13 performs the clustering, it is favorable for the data quantity not to become excessively low for any class. Herein, the class that has the lowest data quantity is called the smallest class. The class that has the highest data quantity is called the largest class. When the data quantity of the smallest class is too low, the data quantity of the smallest class will cause the data quantities extracted from the other classes also to decrease. As a result, the retraining does not easily progress. As a result, it is difficult to obtain the time reduction effect of the retraining. It is therefore favorable to perform the clustering so that the ratio of the data quantity of the smallest class to the data quantity of the largest class is not less than 0.1.

Or, when the data quantity of the smallest class is too low as a result of the clustering, the first training data or the second training data may be added to increase the data quantity of the smallest class. For example, by increasing the data quantity of the smallest class, the ratio of the data quantity of the smallest class to the data quantity of the largest class is adjusted to be not less than 0.1 and not more than 0.25.

The ratio of the data quantity of the smallest class to the data quantity of the largest class is adjusted by modifying the parameters when performing the clustering. As an example, when the clustering is performed by DBSCAN, the ratio can be adjusted by modifying the parameter “MinPts”.

The number of classes into which the feature data is split in the clustering is arbitrary. The number of classes may be high as long as the data quantity of the smallest class is not excessively low. As an example, the clustering is performed so that the number of classes is not less than 3 and not more than 10.

To more efficiently promote the training for small-scale data, it is favorable for the differences between the ratios of the data quantities among the multiple classes to be sufficiently small when the data is extracted by the second extractor 14. For example, it is favorable for the ratios of the data quantities extracted from the classes to be not less than 0.5 and not more than 2. In the example of FIG. 2, it is favorable for the ratios n_{C2}/n_{C1}, n_{C3}/n_{C2}, and n_{C3}/n_{C1} to be not less than 0.5 and not more than 2.

Most favorably, the clustering part 13 extracts the feature data randomly from the classes C1 to C3 so that the data quantities are uniform between the classes C1 to C3. In other words, in the example shown in FIG. 2, it is most favorable for the quantities n_{C1}, n_{C2}, and n_{C3} to be equal.

The invention according to the embodiment will now be described using a more specific example.

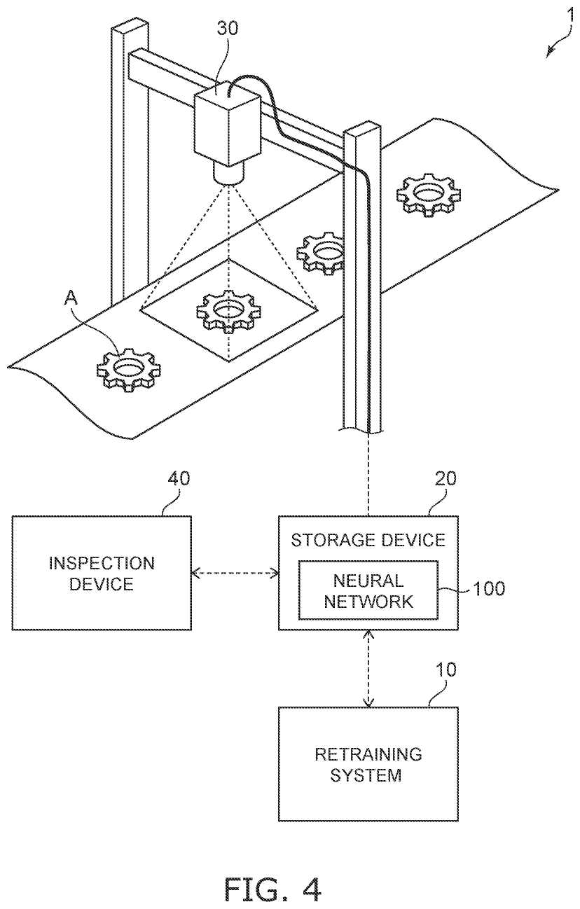

FIG. 4 is a schematic view showing a configuration of an inspection system according to the embodiment.

As shown in FIG. 4, the inspection system 1 according to the embodiment includes the retraining system 10, the storage device 20, an imaging device 30, and an inspection device 40.

The imaging device 30 acquires an image by imaging an article A to be inspected. The imaging device 30 may acquire a video image. In such a case, a still image is cut out from the video image. The imaging device 30 stores the image in the storage device 20.

In the example, the neural network 100 receives input of the image, classifies the image into one of multiple classifications, and outputs the result. The neural network 100 is pretrained before the inspection. The storage device 20 is connected with the imaging device 30 and the inspection device 40 via a network, wired communication, or wireless communication.

The inspection device 40 accesses the storage device 20 and acquires the image acquired by the imaging device 30. The inspection device 40 inputs the image to the neural network 100 and obtains the classification result. Based on the classification result, the inspection device 40 inspects the article visible in the image. The storage device 20 may store the inspected image as second training data for retraining.

For example, the neural network 100 classifies the article visible in the image as one of good (a first classification) or defective (a second classification). Classifications may be set for each defect type; and the defective parts may be classified into one of multiple classifications. When the classification result corresponding to “good” is output from the neural network 100, the inspection device 40 determines the article visible in the image to be good. When the classification result corresponding to “defective” is output from the neural network 100, the inspection device 40 determines the article visible in the image to be defective.

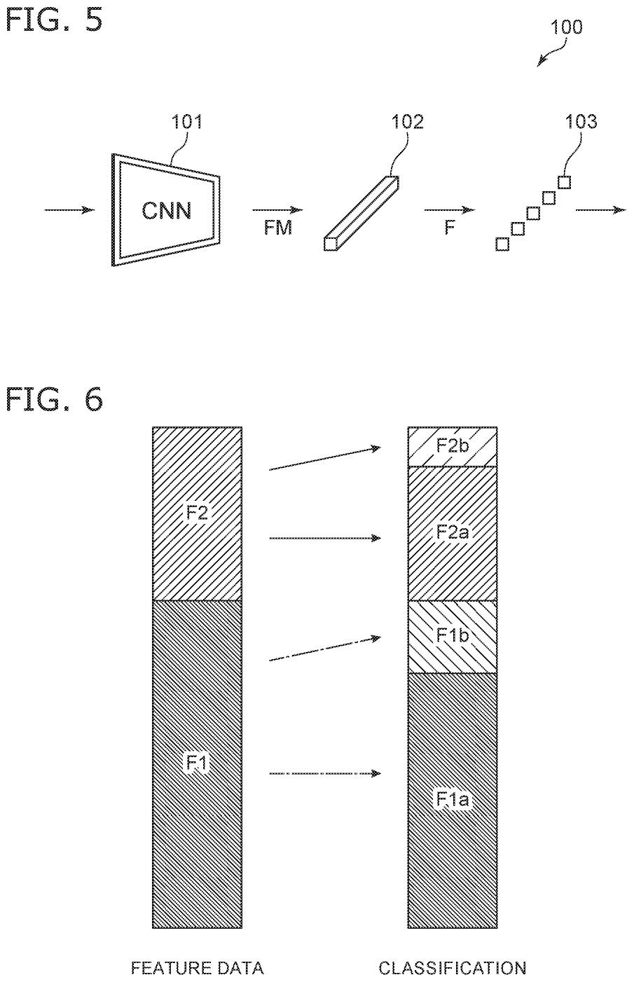

FIG. 5 is a schematic view showing an example of a neural network for classifying.

As shown in FIG. 5, the neural network 100 includes, for example, a convolutional neural network (CNN) 101, a fully connected layer 102, and a fully connected layer 103.

The image is input to the CNN 101. The CNN 101 includes convolutional layers, pooling layers, etc. The CNN 101 outputs a feature map FM according to the input image. The fully connected layer 102 is located after the CNN 101. The fully connected layer 102 connects the data of the feature map FM to the nodes of the fully connected layer 103. The fully connected layer 102 is positioned directly before the fully connected layer 103. Multiple feature data F are output from the fully connected layer 102. The fully connected layer 103 outputs a result representing the classification of the input image.

In the neural network 100 shown in FIG. 5, the first layer of the CNN 101 is the input layer. The fully connected layer 103 is the output layer. The second layer and subsequent layers of the CNN 101 and the fully connected layer 102 are intermediate layers. For example, the first extractor 12 extracts the feature data from the fully connected layer 102.

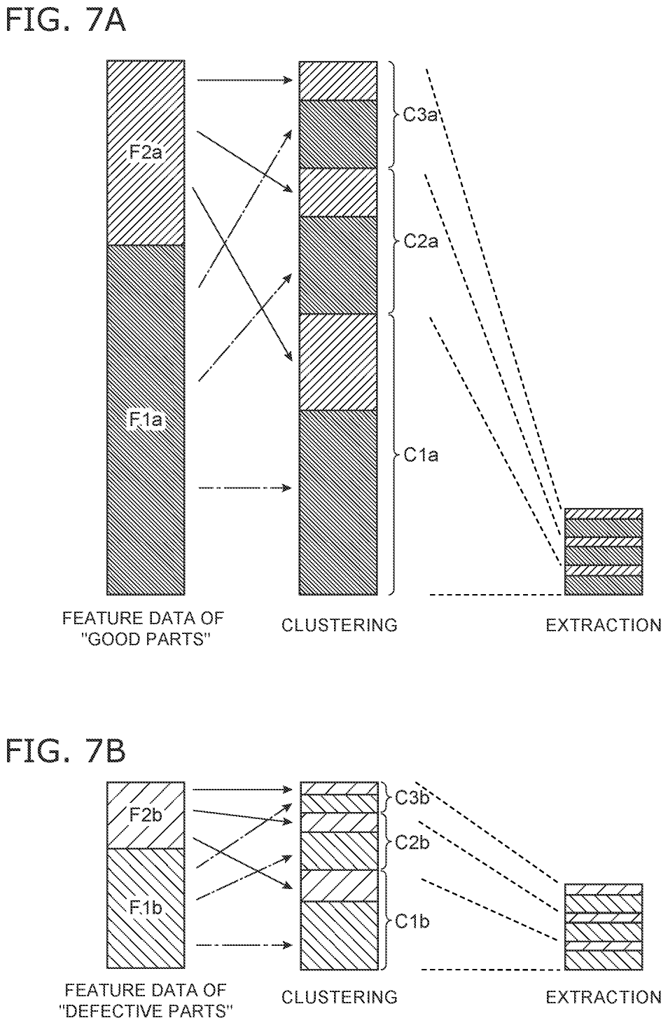

FIGS. 6 to 7B are schematic views for describing an extraction method of the training data.

The first extractor 12 sequentially inputs the multiple first training data and the multiple second training data to the neural network 100 and extracts the multiple first feature data and the multiple second feature data from the fully connected layer 102. At this time, the first extractor 12 also acquires the classification results of the multiple first training data and the multiple second training data output from the neural network 100. As a result, as shown in FIG. 6, first feature data Fla obtained from the first training data classified as “good”, first feature data F1b obtained from the first training data classified as “defective”, second feature data F2a obtained from the second training data classified as “good”, and second feature data F2b obtained from the second training data classified as “defective” are obtained.

The clustering part 13 clusters the feature data into each classification. Specifically, as shown in FIG. 7A, the clustering part 13 clusters the feature data Fla and F2a obtained from the training data classified as “good”. As a result, the feature data F1a and F2a is split into a class C1a, a class C2a, and a class C3a. Also, as shown in FIG. 7B, the clustering part 13 clusters the feature data F1b and F2b obtained from the training data classified as “defective”. As a result, the feature data F1b and F2b is split into a class C1b, a class C2b, and a class C3b.

As shown in FIGS. 7A and 7B, the second extractor 14 extracts feature data from the class C1a to C3a and the class C1b to C3b to reduce the differences between the ratios of the data quantities. For example, the second extractor 14 randomly extracts a uniform number of data from each of the class C1a to C3a and the class C1b to C3b. The updater 15 updates the neural network 100 by using the extracted feature data.

By using the neural network 100 according to the inspection system 1 according to the embodiment, a sensual visual inspection of the tint or the like can be performed with high accuracy. The accuracy of the classifying by the neural network 100 may change when the quality of the input image changes. For example, the quality of the image changes when there is a change of the brightness of the space in which the article A and the imaging device 30 are placed, the relative positional relationship between the article A and the imaging device 30, the appearance of the article A, etc. The inspection accuracy may be reduced by the change of the quality of the image. However, by retraining the neural network 100 with the retraining system 10, it is possible to restore the accuracy of the neural network 100 while reducing the time necessary for retraining. For example, by completing the retraining in a shorter period of time, the retrained neural network 100 is applicable to the inspection at an earlier timing. As a result, the likelihood of a defective part being erroneously determined to be good and passed on can be reduced.

The timing of performing the retraining is determined by any method. For example, the accuracy of the neural network 100 is checked at a prescribed timing. When the accuracy of the neural network 100 falls below a preset threshold, the retraining system 10 retrains the neural network 100. The retraining can use the inspected images up to that point.

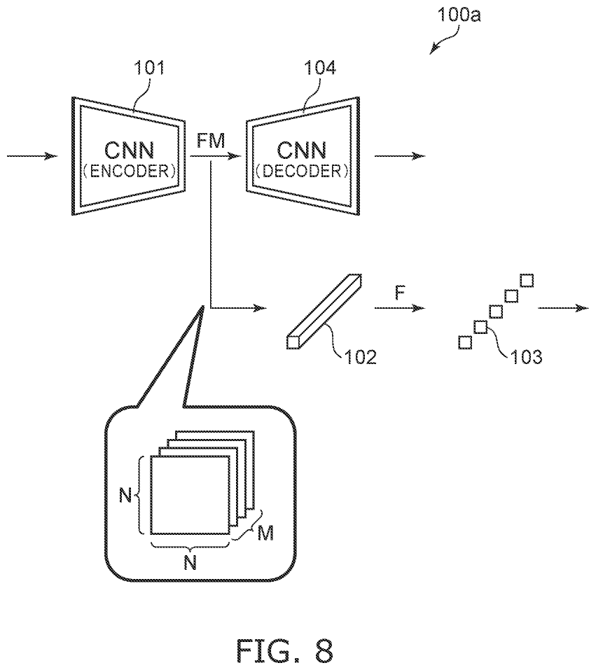

FIG. 8 is a schematic view showing another example of a neural network for classifying.

Instead of the neural network 100, a neural network 100a shown in FIG. 8 may be used. The neural network 100a further includes a CNN 104 in addition to the CNN 101, the fully connected layer 102, and the fully connected layer 103.

The feature map FM that is output from the CNN 101 is input to the fully connected layer 102 and the CNN 104. The function of the fully connected layer 102 of the neural network 100a is the same as the function of the fully connected layer 102 of the neural network 100.

The CNN 104 restores the data size of the feature map FM to the same size as the input data, and outputs the result. In other words, the CNN 101 functions as an encoder; and the CNN 104 functions as a decoder.

For example, the first extractor 12 acquires the feature map FM output from the CNN 101 as the feature data. Specifically, the CNN 101 outputs M feature maps FM having sizes of N×N. The first extractor 12 extracts, as the feature data, data having the dimensions N×N×M corresponding to the M feature maps FM.

### Regression

The neural network 100 shown in FIG. 5 may be trained to perform a regression. In such a case, the fully connected layer 103 outputs values according to the input of an image to the CNN 101. The first extractor 12 can extract the feature data from the fully connected layer 102.

Other than the example shown in FIG. 5, the neural network may be configured to output values according to the input of continuous values, voice, character strings, time-series data, etc.

### Segmentation

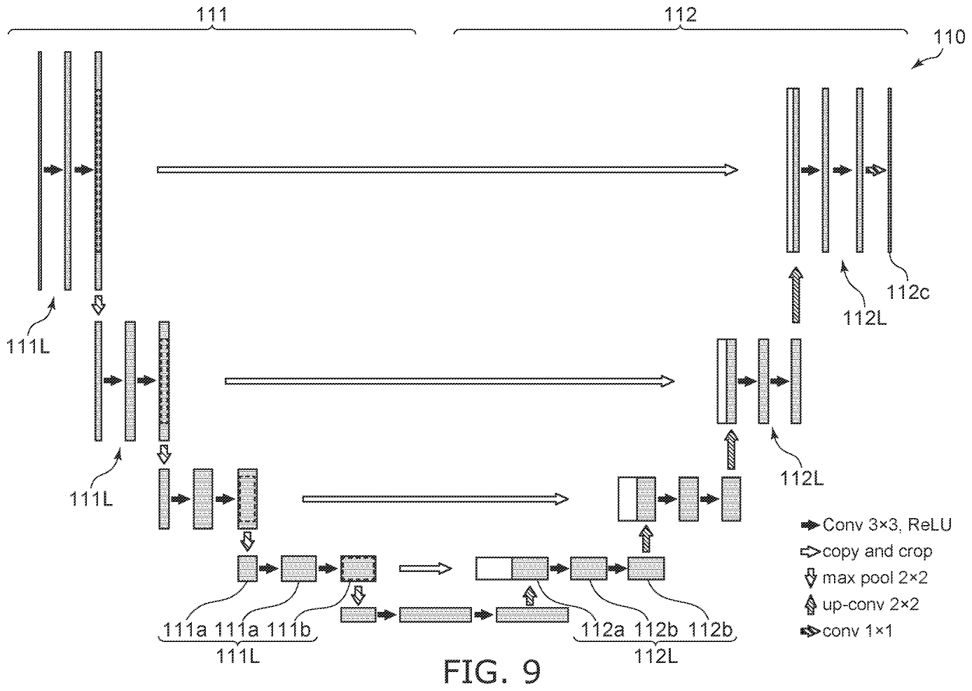

FIG. 9 is a schematic view showing an example of a neural network for segmentation.

The neural network 110 shown in FIG. 9 may be used instead of the neural network 100. The neural network 110 performs segmentation of the image. The image is split into multiple objects by segmentation.

The neural network 110 has a U-Net structure. Specifically, the neural network 110 includes an encoder 111 and a decoder 112. The encoder 111 includes multiple layers 111L. Each layer 111L includes multiple convolutional layers 111a and a pooling layer 111b. The decoder 112 includes multiple layers 112L. Each layer 112L includes an upsampling layer 112a and multiple convolutional layers 112b. A softmax function 112c is located in the final layer of the decoder 112. Also, data having the same sizes as the layers 112L is copied respectively to the layers 112L from the multiple layers 111L.

The first extractor 12 inputs training data to the neural network 110. For example, the first extractor 12 extracts, as feature data, data output from the pooling layer 111b of one of the layers 111L.

The structure of the neural network shown in FIG. 9 is discussed in O. Ronneberger, P. Fischer, and T. Brox, “U-net: Convolutional Networks for Biomedical Image Segmentation”, International Conference on Medical Image Computing and Computer-Assisted Intervention, Springer, pp. 234-241 (2015).

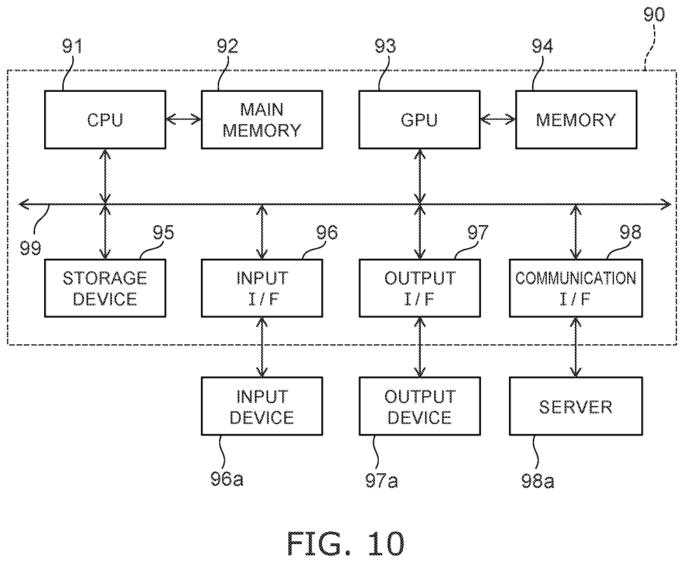

FIG. 10 is a schematic view showing a hardware configuration.

The retraining system 10 and the inspection device 40 each include, for example, a computer 90 (a processing device) shown in FIG. 10. The computer 90 includes a CPU 91, main memory 92, a GPU 93, memory 94, a storage device 95, an input interface 96, an output interface 97, and a communication interface 98.

The main memory 92 stores programs that control the operations of the computer. The storage device 95 stores programs that are necessary for causing the computer to realize the processing described above, and functions as a region where the processing results are stored. In the main memory 92, the stored programs are loaded, and the processing results of the CPU 91 are stored. In the memory 94, programs are loaded, and the processing results of the GPU 93 are stored.

The CPU 91 and the GPU 93 each include processing circuits. The CPU 91 and the GPU 93 each use the main memory 92 and the memory 94 as work memory to execute prescribed programs. For example, when executing a program for retraining, the calculation result of the CPU 91 and the calculation result of the GPU 93 are transferred as appropriate between the main memory 92 and the memory 94. The CPU 91 also controls configurations and executes various processing via a system bus 99.

The storage device 95 stores data necessary for executing the programs and/or data obtained by executing the programs. The storage device 95 may be used as the storage device 20.

The input interface (I/F) 96 connects the computer 90 and an input device 96a. The input I/F 96 is, for example, a serial bus interface such as USB, etc. The CPU 91 and the GPU 93 can read various data from the input device 96a via the input I/F 96.

The output interface (I/F) 97 connects the computer 90 and an output device 97a. The output I/F 97 is, for example, an image output interface such as Digital Visual Interface (DVI), High-Definition Multimedia Interface (HDMI (registered trademark)), etc. The CPU 91 and the GPU 93 can transmit data to the output device 97a via the output I/F 97 and can cause the output device 97a to display an image.

The communication interface (I/F) 98 connects the computer 90 and a server 98a outside the computer 90. The communication I/F 98 is, for example, a network card such as a LAN card, etc. The CPU 91 and the GPU 93 can read various data from the server 98a via the communication I/F 98.

The storage device 95 includes at least one selected from a hard disk drive (HDD) and a solid state drive (SSD). The input device 96a includes at least one selected from a mouse, a keyboard, a microphone (audio input), and a touchpad. The output device 97a includes at least one selected from a monitor, a projector, a speaker, and a printer. A device such as a touch panel that functions as both the input device 96a and the output device 97a may be used.

The hardware configuration shown in FIG. 10 is a favorable example for implementing the invention according to the embodiment. The hardware configuration may be modified as appropriate. For example, according to the processing to be performed, the computer 90 may include multiple GPU 93 and may further include other processors. The computer 90 may not include the GPU 93.

The functions of the retraining system 10 and the inspection device 40 may be realized by one computer or may be realized by two or more computers. For example, one computer 90 may function as the acquisition part 11, the first extractor 12, the clustering part 13, the second extractor 14, and the updater 15 of the retraining system 10. One computer 90 may function as a portion of the acquisition part 11, the first extractor 12, the clustering part 13, the second extractor 14, and the updater 15; and another computer 90 may function as another portion of the acquisition part 11, the first extractor 12, the clustering part 13, the second extractor 14, and the updater 15. In such a case, the one computer 90 and the other computer 90 may transmit and receive data via a network.

For example, a training data extraction device that includes the function of the second extractor 14 is prepared. A feature data extraction device including the functions of the acquisition part 11 and the first extractor 12, a clustering device including the function of the clustering part 13, and an updating device including the function of the updater 15 may be provided separately from the training data extraction device. Or, the training data extraction device may include the function of at least one selected from the acquisition part 11, the first extractor 12, the clustering part 13, and the updater 15.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes the CPU and the GPU to execute the instructions described in the program based on the program. In the computer, the acquisition (or the reading) of the program may be performed via a network.

The embodiments may include the following characteristics.

### (Characteristic 1)

A retraining system retraining a neural network, the neural network being trained by using a plurality of first training data as input data and by using a plurality of first output results as output data, the retraining system comprising:
a first extractor inputting the plurality of first training data to the neural network and respectively extracting a plurality of first feature data from an intermediate layer of the neural network, and inputting a plurality of second training data to the neural network and respectively extracting a plurality of second feature data from the intermediate layer, the plurality of second training data being new;
a clustering part splitting the plurality of first feature data and the plurality of second feature data into a plurality of classes;
a second extractor extracting a portion of the plurality of first feature data and a portion of the plurality of second feature data from the plurality of classes to reduce differences between ratios of data quantities among the plurality of classes; and
an updater updating the neural network by using a portion of the plurality of first training data and a portion of the plurality of second training data, the portion of the plurality of first training data corresponding to the portion of the plurality of first feature data, the portion of the plurality of second training data corresponding to the portion of the plurality of second feature data.

### (Characteristic 2)

The retraining system according to Characteristic 1, wherein
the plurality of classes includes a first class and a second class, and
a ratio of a data quantity extracted from the second class by the second extractor to a data quantity extracted from the first class by the second extractor is closer to 1 than a ratio of a data quantity split into the second class to a data quantity split into the first class.

### (Characteristic 3)

The retraining system according to Characteristic 1, wherein
the second extractor extracts a uniform number of data from each of the plurality of classes.

### (Characteristic 4)

The retraining system according to any one of Characteristics 1 to 3, wherein
the extracting of the portion of the plurality of first feature data and the portion of the plurality of second feature data by the second extractor and the updating of the neural network by the updater are alternately repeated.

### (Characteristic 5)

The retraining system according to any one of Characteristics 1 to 4, wherein
the neural network performs one of classification, image generation, segmentation, object detection, or regression.

### (Characteristic 6)

The retraining system according to any one of Characteristics 1 to 5, wherein
the neural network includes an input layer, the intermediate layer, and an output layer,
the intermediate layer includes a plurality of layers, and
the first extractor extracts the plurality of first feature data and the plurality of second feature data from a layer among the plurality of layers positioned at the output layer side.

### (Characteristic 7)

The retraining system according to any one of Characteristics 1 to 6, wherein
the neural network receives an input of an image and classifies the image into one of a plurality of classifications, and
the clustering part:
   acquires a classification result of the plurality of first training data and a classification result of the plurality of second training data from the neural network, and
   clusters the plurality of first training data and the plurality of second training data into the classifications.

### (Characteristic 8)

The retraining system according to Characteristic 7, wherein
the neural network includes a convolutional layer and a fully connected layer, and
the first extractor respectively extracts, as the plurality of first feature data and the plurality of second feature data, outputs from the fully connected layer when the plurality of first training data and the plurality of second training data are input to the neural network.

### (Characteristic 9)

An inspection system, comprising:
an imaging device acquiring an image of an article; and
an inspection device inputting the image acquired by the imaging device to the neural network updated by the retraining system according to Characteristic 7, and inspecting the article based on a classification result output from the neural network.

According to the embodiments described above, a retraining system, an inspection system, an extraction device, a retraining method, a program, and a storage medium are provided in which the time necessary for retraining can be reduced while suppressing a reduction of the accuracy of the neural network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A retraining system retraining a neural network, the neural network being trained by using a plurality of first training data as input data and by using a plurality of first output results as output data, the retraining system comprising:
a first extractor inputting the plurality of first training data to the neural network and respectively extracting a plurality of first feature data from an intermediate layer of the neural network, and inputting a plurality of second training data to the neural network and respectively extracting a plurality of second feature data from the intermediate layer, the plurality of second training data being new;
a clustering part splitting the plurality of first feature data and the plurality of second feature data into a plurality of classes;
a second extractor extracting a portion of the plurality of first feature data and a portion of the plurality of second feature data from the plurality of classes to reduce differences between ratios of data quantities among the plurality of classes; and
an updater updating the neural network by using a portion of the plurality of first training data and a portion of the plurality of second training data, the portion of the plurality of first training data corresponding to the portion of the plurality of first feature data, the portion of the plurality of second training data corresponding to the portion of the plurality of second feature data.

2. The retraining system according to claim 1, wherein
the plurality of classes includes a first class and a second class, and
a ratio of a data quantity extracted from the second class by the second extractor to a data quantity extracted from the first class by the second extractor is closer to 1 than a ratio of a data quantity split into the second class to a data quantity split into the first class.

3. The retraining system according to claim 1, wherein
the second extractor extracts a uniform number of data from each of the plurality of classes.

4. The retraining system according to claim 1, wherein
the extracting of the portion of the plurality of first feature data and the portion of the plurality of second feature data by the second extractor and the updating of the neural network by the updater are alternately repeated.

5. The retraining system according to claim 1, wherein
the neural network performs one of classification, image generation, segmentation, object detection, or regression.

6. The retraining system according to claim 1, wherein
the neural network includes an input layer, the intermediate layer, and an output layer,
the intermediate layer includes a plurality of layers, and
the first extractor extracts the plurality of first feature data and the plurality of second feature data from a layer among the plurality of layers positioned at the output layer side.

7. The retraining system according to claim 1, wherein
the neural network receives an input of an image and classifies the image into one of a plurality of classifications, and
the clustering part:
acquires a classification result of the plurality of first training data and a classification result of the plurality of second training data from the neural network, and
clusters the plurality of first training data and the plurality of second training data into the classifications.

8. The retraining system according to claim 7, wherein
the neural network includes a convolutional layer and a fully connected layer, and
the first extractor respectively extracts, as the plurality of first feature data and the plurality of second feature data, outputs from the fully connected layer when the plurality of first training data and the plurality of second training data are input to the neural network.

9. An inspection system, comprising:
an imaging device acquiring an image of an article; and
an inspection device inputting the image acquired by the imaging device to the neural network updated by the retraining system according to claim 7, and inspecting the article based on a classification result output from the neural network.

10. An extraction device extracting data for retraining a neural network, the neural network being trained by using a plurality of first training data as input data and by using a plurality of first output results as output data,
the extraction device being configured to:
acquire a result of splitting a plurality of first feature data and a plurality of second feature data into a plurality of classes, the plurality of first feature data being respectively extracted from an intermediate layer of the neural network when the plurality of first training data is input to the neural network, the plurality of second feature data being respectively extracted from the intermediate layer when a plurality of second training data is input to the neural network, the plurality of second training data being new; and
extract a portion of the plurality of first feature data and a portion of the plurality of second feature data from the plurality of classes to reduce differences between ratios of data quantities among the plurality of classes.

11. A retraining method of retraining a neural network, the neural network being trained by using a plurality of first training data as input data and by using a plurality of first output results as output data, the retraining method comprising:
inputting the plurality of first training data to the neural network and respectively extracting a plurality of first feature data from an intermediate layer of the neural network;
inputting a plurality of second training data to the neural network and respectively extracting a plurality of second feature data from the intermediate layer, the plurality of second training data being new;
splitting the plurality of first feature data and the plurality of second feature data into a plurality of classes;
extracting a portion of the plurality of first feature data and a portion of the plurality of second feature data from the plurality of classes to reduce differences between ratios of data quantities among the plurality of classes; and
updating the neural network by using a portion of the plurality of first training data and a portion of the plurality of second training data, the portion of the plurality of first training data corresponding to the portion of the plurality of first feature data, the portion of the plurality of second training data corresponding to the portion of the plurality of second feature data.

12. The retraining method according to claim 11, wherein
the plurality of classes includes a first class and a second class, and
in the extracting of the portion of the plurality of first feature data and the portion of the plurality of second feature data, a ratio of a data quantity extracted from the second class to a data quantity extracted from the first class is closer to 1 than a ratio of a data quantity split into the second class to a data quantity split into the first class.

13. A non-transitory computer-readable storage medium configured to store a program,
the program causing a computer to execute the retraining method according to claim 11.
